(19) United States
(12) Patent Application Publication
(10) Pub. No.: US 2023/0213279 A1
(43) Pub. Date: Jul. 6, 2023

(54) LIGHTER THAN AIR TRANSPORTATION SYSTEM USING CRYOGENIC ENERGY STORAGE

(71) Applicant: ANUMÁ AEROSPACE, LLC, Raleigh, NC (US)

(72) Inventor: James Douglas Little, Raleigh, NC (US)

(21) Appl. No.: 18/149,764

(22) Filed: Jan. 4, 2023

Related U.S. Application Data
(60) Provisional application No. 63/296,526, filed on Jan. 5, 2022.

(51) Int. Cl. F25J 3/04; F17C 13/00; B01D 53/26; B01D 53/14; B01D 3/14

(52) U.S. Cl. CPC F25J 3/04018; F17C 13/00; B01D 53/26; B01D 53/1475; B01D 3/143; F25J 3/0406; F25J 3/04066; F25J 3/04072; F17C 2223/0161; F17C 2270/0189; F17C 2265/066; F17C 2221/014; F25J 2205/84; F25J 2205/30

(57) ABSTRACT

A method for generating liquefied gas is provided. The method includes receiving air, refining the air to create refined air, performing liquefaction on refined air to form liquefied gas, and transferring at least one constituent liquefied gas of the liquefied gas to a storage tank in a lighter than air aircraft. The constituent liquefied gas(es) is configured to serve as an energy source for the lighter than air aircraft. The method may include distilling the liquefied gas to obtain liquid nitrogen and one or more other constituent gases. The liquid nitrogen may be configured to store at least 250 kilojoule per liter of energy. Additionally, the air may be refined to create refined air by compressing the air, separating water from the air, scrubbing carbon dioxide from the air, and/or filtering dust from the air. The method may be carbon-neutral or carbon-negative.

### CROSS-REFERENCE TO RELATED APPLICATION(S)

This application claims priority to U.S. provisional Patent Application No. 63/296,526, filed Jan. 5, 2022, entitled “Lighter Than Air Transportation System Using Cryogenic Energy Storage,” which is hereby incorporated by reference in its entirety.

### FIELD OF THE INVENTION

Embodiments of the present invention relate generally to a lighter than air (LTA) transportation system that uses cryogenic energy storage.

### BACKGROUND OF THE INVENTION

Lighter than air (LTA) transportation systems provide many benefits over traditional transportation systems, such as being more environmentally friendly. However, existing energy storage mediums for LTA transportation systems possess various deficiencies. Electrolytic battery cells, hydrogen gas storage mediums, liquid hydrogen storage mediums, or ammonia storage mediums are often costly to implement. Additionally, electrolytic batteries, hydrogen based fuels, ammonia based fuels, and petroleum based fuels present fire or explosion risks. Furthermore, the mass of existing storage mediums is often very large, with pressurized storage being necessary for storage in the storage medium. These storage mediums often require very low storage temperatures. Where liquid hydrogen is being stored, the storage temperature is −253 degrees Celsius, and expensive equipment is often required to maintain the liquid hydrogen at this storage temperature.

Additionally, in some other LTA transportation systems, combustion byproducts and carbon dioxide are often released into the environment as the systems consume energy. Furthermore, where LTA transportation systems rely upon fuels or electrolytic batteries, users of the systems are required to frequently return to a fueling station, and this restricts the freedom of users as they navigate.

### BRIEF SUMMARY OF THE INVENTION

Various embodiments described herein utilize air liquefaction to generate liquefied gases such as liquid nitrogen that may be utilized as an energy source for LTA transportation systems, such as LTA aircraft. Air liquefaction may be achieved through the Hampson-Linde, Siemens, Claude cycles, or their variations. These cycles may use various combinations of compression, expansion, and cooling of ambient air to reduce its volume by a ratio, for example, of approximately 700:1. The inverse expansion ratio of 1:700 represents the storage of approximately 287 kilojoules per liter of energy. In some embodiments, the liquefied gases may be stored with at least 250 kilojoules per liter of energy. The resultant liquefied gases may be stored in insulated, low-pressure storage tanks at a temperature of approximately −196° C. Liquefied gases may be transferred to an LTA aircraft, where the liquefied gases may be expanded to recover the stored energy to produce electrical power that may be utilized to power the LTA aircraft.

Liquefied gas production and storage equipment is technologically mature, reliable, and relatively inexpensive when compared to other energy storage mediums, such as electrolytic battery cells, hydrogen gas, liquid hydrogen, or ammonia. Liquefied gas production and storage equipment has an energy density similar to lithium-ion battery cells but is far less expensive. Liquefied gas production and storage equipment utilize air and nitrogen, and these gases do not pose the fire or explosion risks that exist with electrolytic batteries, hydrogen based fuels, ammonia based fuels, and petroleum based fuels. Since liquefied gases do not require pressurized storage tanks for storage, liquefied gases may be stored with a storage mass that is far less than the storage mass for gaseous hydrogen and ammonia. Additionally, liquefied air and liquefied nitrogen may be stored at a storage temperature of −196 degrees Celsius, which is significantly higher in temperature than the required storage temperature of −253 degrees Celsius for liquid hydrogen—this may make maintaining the storage temperature for liquid air and liquid nitrogen far easier than maintaining the storage temperature of liquid hydrogen.

Various embodiments contemplated herein are environmentally conscious in various respects. No combustion byproducts are created as expansion of air occurs, making the expansion of air environmentally benign. In some embodiments, systems may be entirely carbon neutral. For example, systems may utilize electrical energy from renewable sources to produce the liquefied gas products. Additionally, in some embodiments, the system may be carbon negative. For example, systems may be configured to filter out carbon dioxide (CO2) from air during liquefied gas production, and this carbon dioxide may be utilized for other beneficial purposes such as for use in the manufacturing of airship components. In this way, the carbon dioxide may be prevented from being released into the environment.

In some embodiments, the LTA aircraft may possess light weight air liquefaction equipment, providing the LTA aircraft with the ability to produce liquefied gas and to store the liquefied gas. Thus, an LTA aircraft may possess the additional advantage of being less geographically limited during navigation. Indeed, the atmosphere is available for liquefaction and expansion anywhere in the world and at any altitude. Thus, operators of LTA aircraft using cryogenic energy storage have more freedom to travel to various locations.

An LTA aircraft may utilize cryogenic energy storage. In some embodiments, electricity, preferably from renewable sources, may be used to run land-based or sea surface-based air liquefaction equipment. Air liquefaction equipment may be Hampson-Linde, Siemens, or Claude-cycle air liquefaction equipment. The air liquefaction equipment may reduce ambient air volume by approximately 700 times, resulting in the storage of approximately 287 kJ/L energy. Air may be refined prior to liquefaction—air may be filtered to remove water vapor, and carbon dioxide may be scrubbed from air. The scrubbed carbon dioxide may be stored for later conversion or use. Liquefied air may be fractionally distilled into atmospheric constituents, such as nitrogen, oxygen, and argon. The nitrogen and oxygen may be utilized at various stages of the processes described herein in some embodiments, and/or these substances may be stored in storage tanks for later uses in other embodiments.

Purified cryogenic nitrogen has various qualities that make it very useful. Purified cryogenic nitrogen is inert, so it will not readily undergo chemical reactions with other chemical substances. This may increase the safety of use where purified cryogenic hydrogen is utilized as an energy source in LTA aircraft and where purified cryogenic hydrogen is stored in storage facilities. The use of purified cryogenic nitrogen may reduce the cost and/or complexity of safety systems utilized in the LTA aircraft and in any storage facilities. Additionally, purified cryogenic nitrogen is odorless, which is beneficial for those at storage facilities and for users of LTA aircraft utilizing cryogenic nitrogen. Purified cryogenic nitrogen is also non-corrosive, so the substance will not tend to degrade the materials of components utilized within the LTA aircraft as a result of corrosion or degrade storage tanks and other equipment at storage facilities. Also, the purified cryogenic nitrogen is nonflammable, which again tends to improve upon safety concerns presented by other fuel sources. Purified cryogenic nitrogen also has a lower density (804 kilograms per cubic meter at −196 degrees Celsius) than cryogenic air (870 kilograms per cubic meter at −196 degrees Celsius), so LTA aircraft utilizing purified cryogenic nitrogen may have a reduced weight and the total amount of energy required to maintain the LTA aircraft at a desired altitude may be reduced.

In some embodiments, expansion equipment for converting the cryogenic medium into mechanical energy may be flexible enough to run on either cryogenic nitrogen, air, or other gases. This may be advantageous in emergencies and remote locations, where only unseparated cryogenic air or other gases are available, or when using simplified and lighter-weight onboard air liquefaction equipment powered with onboard solar-photovoltaic cells. Additionally, in some embodiments, air liquefaction equipment sets may be powered with solar-photovoltaic cells onboard LTA aircraft, and this may leverage available daytime solar energy to store energy for use at night or during periods of poor solar availability.

In some embodiments, carbon dioxide may be scrubbed from compressed air during the liquefaction process, and this scrubbed carbon dioxide may be utilized for beneficial purposes while avoiding the emission of the carbon dioxide into the atmosphere. For example, scrubbed carbon dioxide may undergo processing to extract carbon from the carbon dioxide so that the carbon may be utilized in the manufacture of various components of the LTA aircraft.

In an example embodiment, a method for generation of liquefied gas is provided. The method includes receiving air, refining the air to create refined air, performing liquefaction on the refined air to form liquefied gas, and transferring at least one constituent liquefied gas of the liquefied gas to a storage tank in a lighter than air aircraft. The at least one constituent liquefied gas of the liquefied gas is configured to serve as an energy source for the lighter than air aircraft.

In some embodiments, the method may also include distilling the liquefied gas to obtain liquid nitrogen and one or more other constituent gases, and the at least one constituent liquefied gas of the liquefied gas may include the liquid nitrogen. Additionally, in some embodiments, the liquid nitrogen may be configured to store at least 250 kilojoule per liter of energy. Furthermore, in some embodiments, the liquid nitrogen may possess a storage temperature of greater than approximately −200 degrees Celsius. In some embodiments, distilling the liquefied gas may also generate oxygen and argon.

In some embodiments, refining the air to create refined air may include at least one of compressing the air, separating water from the air, scrubbing carbon dioxide from the air, or filtering dust from the air. In some embodiments, the method may be carbon-neutral or carbon-negative. Additionally, in some embodiments, refining the air to create refined air may include scrubbing carbon dioxide from the air, and the method may also include performing molten carbonate electrolysis to separate carbon from oxygen. Furthermore, in some embodiments, the method may also include manufacturing components of another lighter than air aircraft utilizing separated carbon.

In another example embodiment, a lighter than air aircraft is provided. The lighter than air aircraft includes an air inlet that is configured to receive air. The lighter than air aircraft also includes one or more refinement equipment that is configured to refine the air to generate refined air. The lighter than air aircraft also includes liquefaction equipment that is configured to perform liquefaction on the refined air to form liquefied gas. The lighter than air aircraft also includes a storage tank that is configured to store at least one constituent liquefied gas of the liquefied gas. The lighter than air aircraft also includes a heat exchanger. The heat exchanger is configured to induce a phase change in the at least one constituent liquefied gas from liquid to gas. The phase change generates energy, and the lighter than air aircraft is configured to use the energy to power one or more components or systems of the lighter than air aircraft.

In some embodiments, the one or more refinement equipment may include at least one of an air compressor for compressing the air, a water filter for separating water from the air, a carbon dioxide scrubber configured to scrub carbon dioxide from the air, or a dust filter for filtering dust from the air. Additionally, in some embodiments, the one or more refinement equipment may include an air compressor for compressing the air, and the air compressor may be a three-stage compressor.

In some embodiments, the liquefied gas may be configured to store at least 250 kilojoule per liter of energy. In some embodiments, the lighter than air aircraft may be carbon-neutral or carbon-negative. In some embodiments, the liquefaction equipment may be configured to perform liquefaction using at least one of a Hampson-Linde cycle, a Siemens cycle, or a Claude cycle.

In another example embodiment, a lighter than air aircraft is provided. The lighter than air aircraft includes a storage tank that is configured to store a liquefied gas and a heat exchanger. The lighter than air aircraft is configured to receive the liquefied gas for the storage tank from a liquefied gas production and storage facility or a second lighter than air aircraft. The heat exchanger is configured to induce a phase change in the liquefied gas from liquid to gas. The phase change generates energy. Furthermore, the lighter than air aircraft is configured to use the energy to power one or more components or systems of the lighter than air aircraft.

In some embodiments, the liquefied gas may be nitrogen. In some embodiments, the heat exchanger may utilize at least one of heat from ambient air or solar energy. In some embodiments, the lighter than air aircraft may also include a turboexpander and a generator. The liquefied gas may be expanded through the turboexpander to convert the energy to rotational motion, and the generator may be configured to convert rotational motion into electrical energy.

In some embodiments, the lighter than air aircraft may also include a deployable boom. The lighter than air aircraft may be configured to receive the liquefied gas from the second lighter than air aircraft using the deployable boom or to transfer the liquefied gas to the second lighter than air aircraft using the deployable boom.

### BRIEF DESCRIPTION OF THE DRAWINGS

Having thus described the invention in general terms, reference will now be made to the accompanying drawings, which are not necessarily drawn to scale, and wherein:

FIG. 1 is a schematic view illustrating an example LTA aircraft flying in for a direct fill of liquefied gas, in accordance with some embodiments discussed herein;

FIG. 2 is a schematic view illustrating an example LTA tanker obtaining liquefied gas and then transferring the liquefied gas to another LTA aircraft by aerial transfer, in accordance with some embodiments discussed herein;

FIG. 3 is a schematic diagram of an example system for production of liquefied gas that may be used on land, at sea, or onboard an LTA aircraft, in accordance with some embodiments discussed herein;

FIG. 4 is a schematic view illustrating an example hybrid liquefied gas-electric power generation and propulsion system for an LTA aircraft, in accordance with some embodiments discussed herein; and

FIGS. 5A and 5B are block diagrams illustrating an example non-pollutant cargo transportation system with built-in carbon capture and sequestration, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. It should be understood that the drawings and detailed descriptions here are not intended to limit implementations to the particular form disclosed but that the intention is to cover all modifications, equivalents and alternatives falling within the scope and spirit of the description herein.

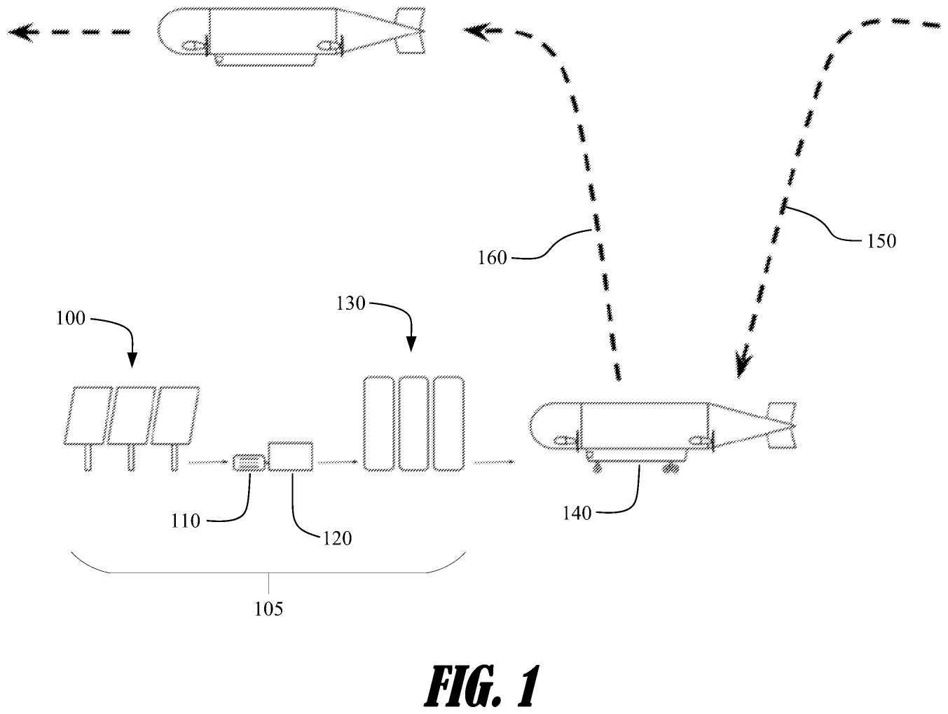

In some embodiments, liquefied gas production may be performed at a liquefied gas production and storage facility remote from an LTA aircraft, and an LTA aircraft may fly in for direct fill of liquefied gas. FIG. 1 is a schematic view illustrating an example LTA aircraft 140 flying in for a direct fill of liquefied gas. Electrical energy may be generated through one or more renewable sources 100. Renewable sources 100 may be solar photovoltaics in some embodiments, but renewable sources 100 may take other forms. The renewable source(s) 100 may be used to run a motor 110, and the motor 110 may be an electric motor. The motor 110 may power air liquefaction equipment 120. Once powered, the air liquefaction equipment 120 may produce liquefied gases, and these liquefied gases are pumped into and stored in one or more storage tanks 130. In some embodiments, the liquefied gases may undergo distillation to separate various atmospheric constituents within the liquefied gases (e.g. nitrogen, oxygen, argon, etc.), and each of these atmospheric constituents may be stored in separate storage tank(s) 130. Storage tank(s) 130 may be insulated and/or unpressurized storage tanks 130. Additionally, when stored within the storage tanks 130, the liquefied gases may be kept below their boiling points to limit boil-off losses.

As illustrated in FIG. 1, an LTA aircraft 140 may fly to a location proximate to the storage tank(s) 130. In the illustrated embodiment of FIG. 1, the LTA aircraft 140 follows the path 150 downwardly towards the liquefied gas production and storage facility 105 where its onboard liquefied gas storage tank is filled. Once filling is complete, the LTA aircraft 140 takes off along path 160 and resumes its course to its destination. These liquefied gas production and storage facilities 105 may be placed at the beginning, end, or at any point along a route.

Liquefied gas that has been transferred to an LTA aircraft may be stored in one or more storage tanks onboard the LTA aircraft. Liquefied gas may be pumped from the storage tank of the liquefied gas production and storage facility 105, and the liquefied gas may be pumped onboard the LTA aircraft 140. Liquefied gas may be transferred to the one or more storage tanks within the LTA aircraft 140 in some embodiments.

Once in the LTA aircraft 140, the liquefied gas may be pumped using heat exchangers using heat from ambient air or solar thermal energy. This heat may induce a phase change from liquid to gas and may expand the gas, such as through a turboexpander, converting the stored kinetic energy to rotational motion. This rotational motion may be converted into electrical energy with an electrical generator. Electrical energy that is produced may be used for various purposes on the LTA aircraft 140. For example, the electrical energy may be utilized to power electric motors for propulsion, electrical servomechanisms for attitude controls, avionics, navigation, radio equipment, and/or other applications aboard the LTA aircraft. However, other uses for the electrical energy can also be made.

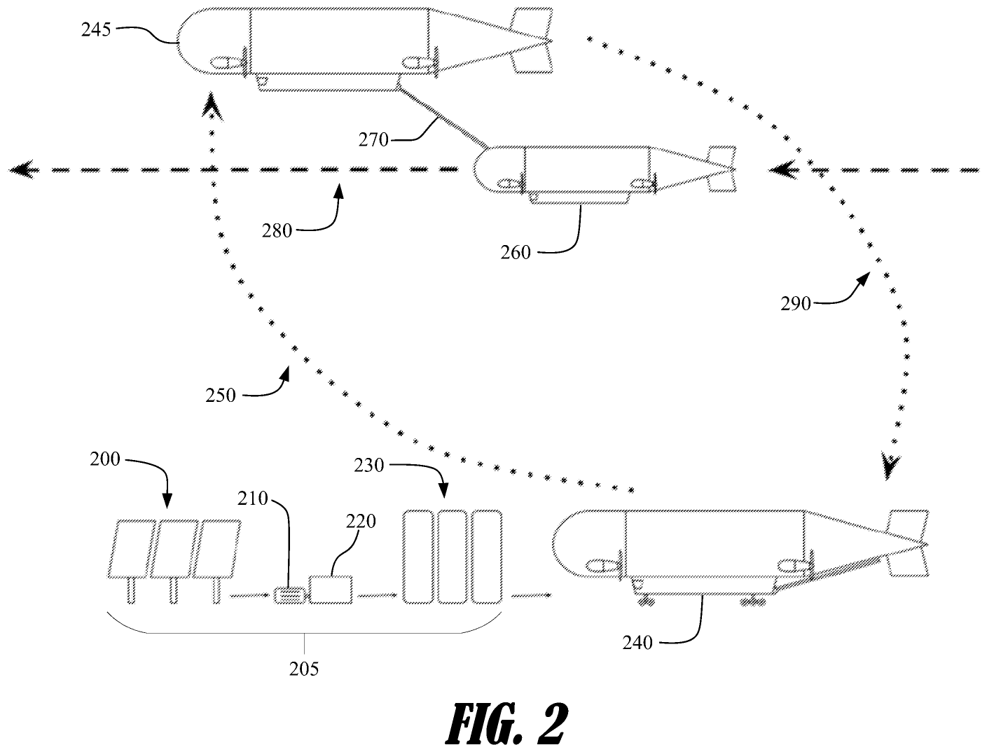

In some embodiments, an LTA tanker may fly into a liquefied gas production and storage facility so that a storage tank of the LTA tanker may be filled with liquefied gas, and the LTA tanker may then fly to rendezvous points along predetermined transport routes where other LTA aircraft may rendezvous with the LTA tanker so that the LTA aircraft may refill liquefied gas by aerial transfer. FIG. 2 is a schematic view illustrating an example LTA tanker obtaining liquefied gas and then transferring the liquefied gas to another LTA aircraft by aerial transfer.

As illustrated in FIG. 2, electrical energy generated through renewable sources 200, such as solar photovoltaics, is used to run an electrical motor 210, powering air liquefaction equipment 220 to produce liquefied gases, which are pumped into and stored in insulated, unpressurized storage tanks 230. An LTA tanker 240 is provided as one type of LTA aircraft. The LTA tanker 240 may land at the liquefied gas production and storage facility 205 so that its one or more liquefied gas storage tanks may be filled with liquefied gas. This liquefied gas may be cryogenic, liquefied gas. The LTA tanker 240 then takes off and navigates to a predetermined position along a designated transport route 250. Additionally, another LTA aircraft 260 may travel along path 280 to a location proximate to the stationed LTA tanker 245. When an LTA aircraft 260 arrives and needs its liquefied gas storage tanks refilled, the stationed LTA tanker 245 may deploy, for example, its liquefied gas transfer boom 270. The boom 270 may be a retractable, gimballed boom in some embodiments. The LTA aircraft 260 flies in formation with the stationed LTA tanker 245 while the boom is attached to the intake port of the LTA aircraft 260. The liquefied gas storage tanks of the LTA aircraft 260 are filled from the stationed LTA tanker 245 via the boom 270. When filling is complete, the LTA aircraft 260 disengages from the boom 270 and continues its journey along the transport route 280. The stationed LTA tanker 245 may or may not refill more than one LTA aircraft 260, or the same LTA aircraft 260 multiple times. When the stationed LTA tanker 245 is empty, it returns along path 290 to the liquefied gas production and storage facility 205 to refill its liquefied gas storage tanks. This cycle continuously repeats as necessary.

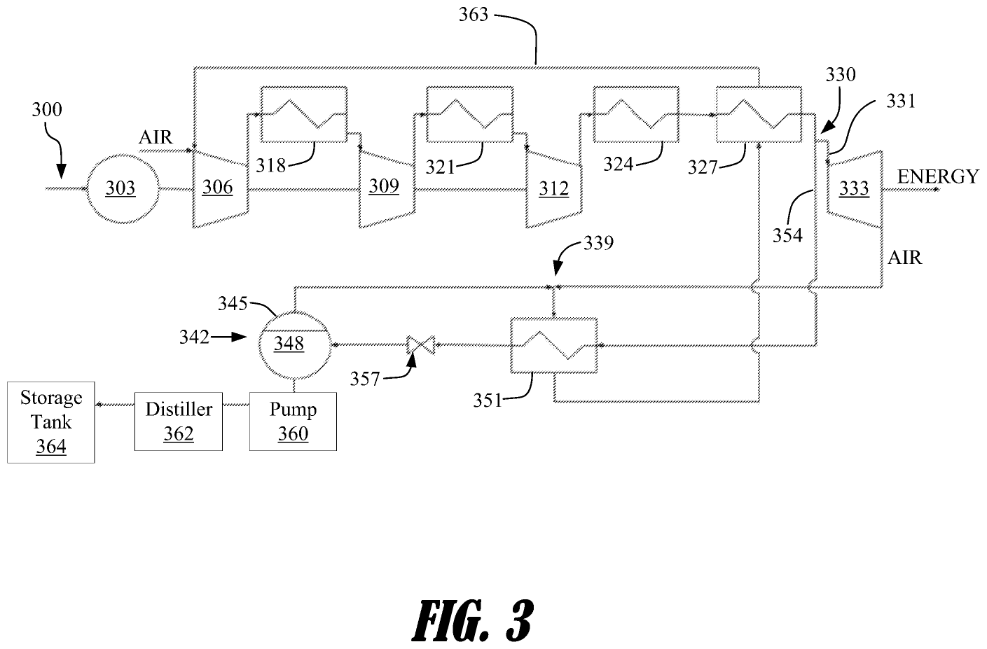

FIG. 3 is a schematic diagram of an example system for production of liquefied gas that may be used on land, at sea, and/or onboard an LTA aircraft. In FIG. 3, a Claude cycle is used to produce liquefied gas. However, Hampson-Linde and Siemens cycles may also be used for liquefied gas production, but are not shown. Electrical energy generated through renewable resources 300 is conducted to an electrical motor 303. The electric motor shaft turns a three-stage compressor including a first stage compressor 306, a second stage compressor 309, and a third stage compressor 312. As the 3-stage compressor turns, air is drawn into the first stage compressor 306, where the air is compressed and exits the first stage compressor 306 and is run through an intercooler 318 where heat generated through the compression process is rejected. This pressurized and cooled air is then drawn into the second stage compressor 309 where the air is further compressed and is then run through a second intercooler 321 where heat generated through the compression process is rejected. This pressurized and cooled air is then drawn into the third stage compressor 312 where the air is further compressed and is then run through a third intercooler 324 where heat generated through the compression process is rejected.

After running through the three-stage compressor, air may be high-pressure air that has been cooled to a temperature near the ambient temperature. The air may then pass through a regenerator 327. The regenerator 327 may be a heat exchanger. Upon leaving the regenerator 327, the air flow is divided into two separate lines at junction 330. For example, fifteen percent of the air flow may pass through a first line 331 into an expander 333, but other amounts of air may flow through the first line 331 to the expander 333 in other embodiments.

The expander 333 may be a turboexpander in some embodiments, and the expander 333 may be configured to convert stored energy (which may be kinetic energy) to rotational motion. This rotational motion may be converted into electrical energy with an electrical generator. Electrical energy that is produced may be used for various purposes on the LTA aircraft 140 (see FIG. 1) or at a liquefied gas production and storage facility 105 (see FIG. 1). For example, the electrical energy may be utilized to power electric motors for propulsion, electrical servomechanisms for attitude controls, avionics, navigation, radio equipment, and/or other applications aboard the LTA aircraft. However, other uses for the electrical energy can also be made.

The remaining air may pass through a second line 354. The air passing through the expander 333 produces energy. In some embodiments, the expander 333 produces at least 250 kilojoules of energy for each liter of liquefied gas. In some embodiments, the expander 333 produces approximately 287 kilojoules of energy for each liter of liquefied gas. The air exiting the expander 333 is substantially cooled. This cooled air from the expander 333 is then combined at junction 339 with gas 345 from the liquid/gas separator 342 and put through a second regenerator 351, where it is used to chill the compressed air coming in the second line 354 from the junction 330. The second regenerator 351 may be a heat exchanger. The chilled, compressed air coming out of the second regenerator 351 passes into a valve 357 where it is further cooled, liquefying a portion of the air and passing into the liquid/gas separator 342. The valve 357 may be a well-insulated throttling valve in some embodiments, and the valve 357 may be a Joule-Thomson valve in some embodiments. Liquefied air 348 may then be pumped via a pump 360 to a distiller 362 for fractional distillation and/or to a storage tank 364 so that liquified air 348 may be stored for later distribution. The gas 345 from the liquid/gas separator 342 and the gas from the expander 333, which combine at junction 339 to pass through the second regenerator 351, then passes through the first regenerator 327 to pre-cool the gas passing through the other side of the first regenerator 327 before it is divided at junction 330. After pre-cooling the incoming gas in the first regenerator 327, this gas may be recycled back to the intake 363 and mixed into the incoming air.

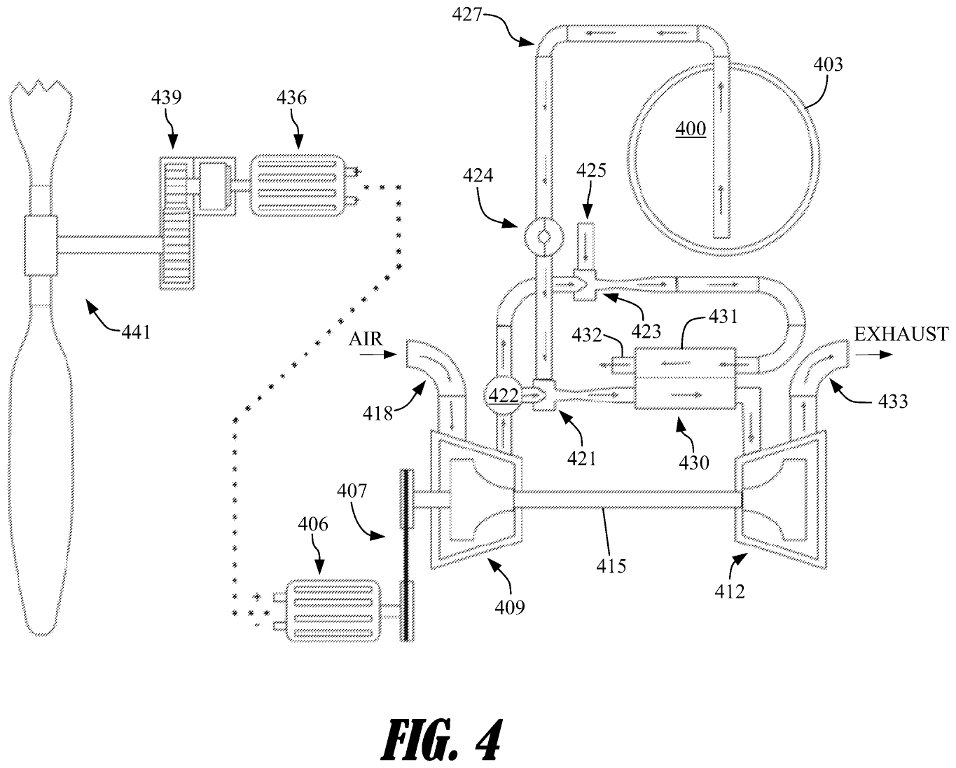

FIG. 4 is a schematic view illustrating an example hybrid liquefied gas-electric power generation and propulsion system for an LTA aircraft. Liquefied gas 400 is stored in an insulated, low-pressure storage tank 403 aboard an LTA aircraft. To start the power generation system, the starter/generator 406 draws power from an onboard starter battery (not shown), which is connected to common shaft 415 by a reduction mechanism 407. The starter/generator 406 turns the gas compressor 409 and gas expander 412 which are both connected to the common shaft 415. The operator may open the control valve 424. The gas compressor 409 draws in ambient air through the air inlet 418. The gas compressor 409 compresses the air, heats the air, and pumps the air through flow splitter 422, with some of the hot air flowing to air ejector 421, which creates negative pressure that draws in liquefied gas 400 from the liquefied gas storage tank 403 through the liquefied gas intake 427 and the control valve 424. The liquefied gas 400 mixes with the hot air from the gas compressor 409 in the air ejector 421, where the mixed gases then pass into the cold-side heat exchanger 430 where the mixed gases are heated through indirect contact with ambient air or air heated with solar thermal energy. The air in the hot-side heat exchanger 431 may be mixed with the additional flow of air from gas compressor 409. The air in the hot-side heat exchanger 431 may pass through the air ejector 423, and this may create negative pressure that draws in ambient or solar heated air at inlet 425, mixing air entering at inlet 425 with hot air from the gas compressor 409. This mixed air may pass through hot-side heat exchanger 431. In some embodiments, the air exiting hot-side heat exchanger 431 may be recycled to the solar heater for reheating. In some embodiments, the air exiting the hot-side heat exchanger 431 may be vented to the atmosphere 432.

The now heated air flowing from the cold-side heat exchanger 430 now expands through the gas expander 412 generating power on the common shaft 415. The common shaft then turns the gas compressor 409 to sustain the system for as long as there is liquefied gas 400 to pull from the storage tank 403. The expanded gas is exhausted to the atmosphere through the gas outlet 433. The shaft 415 also turns the reduction mechanism 407 which in turn drives the starter/generator 406. This may induce the starter/generator 406 to generate electrical energy which is then distributed to one or more propulsion unit motors 436. The propulsion unit motors 436 in turn convert the electrical energy into rotational motion, transmitting that motion, for example, through a clutch and reduction gearbox 439 to an aircraft propeller 441, which provides propulsion for the LTA aircraft. Generated electrical energy may also be used for other purposes in the aircraft.

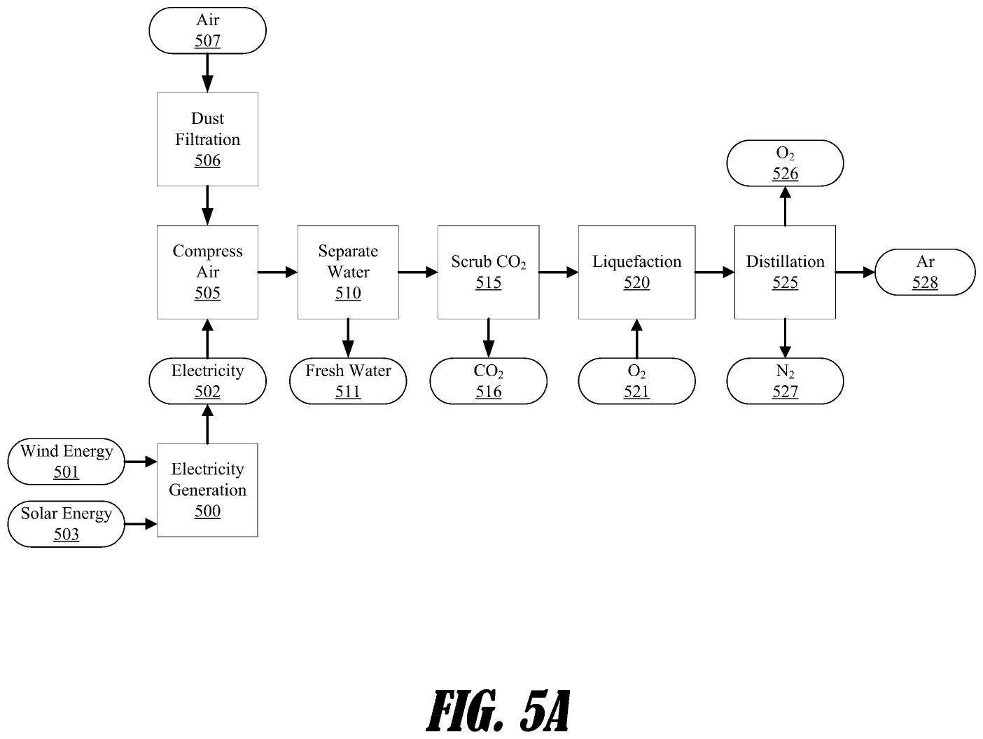

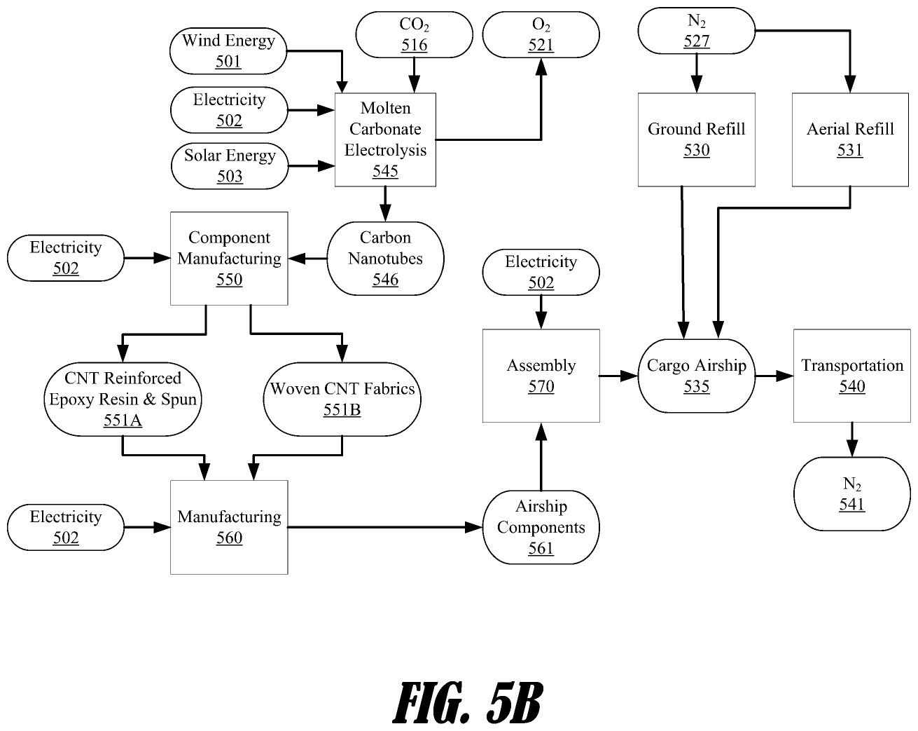

Methods are also contemplated for the generation of liquefied gases. FIG. 5A and 5B are block diagrams illustrating an example non-pollutant cargo transportation system with built-in carbon capture and sequestration. Starting with FIG. 5A, electricity generation 500 occurs using wind energy 501 and solar energy 503. Electricity generation 500 results in the generation of electricity 502, and this electricity 502 may be considered renewable electricity. As described further herein, the electricity 502 may be utilized to provide energy during various processes described in FIG. 5B.

Looking again at FIG. 5A, air 507 is introduced. The air 507 may be introduced from the atmosphere or from some other source. The air 507 may undergo dust filtration 506 using a dust filter in some embodiments. The filtered air may be compressed at operation 505, and electricity 502 generated during operation 500 may be utilized to compress the filtered air. The compressed air is run through water separation 510, and fresh water 511 may be generated as an output of water separation 510 alongside dewatered, compressed air. The dewatered, compressed air generated by water separation 510 is run through a carbon dioxide scrubber 515, which removes carbon dioxide (CO2) 516. In some embodiments, the carbon dioxide 516 may be stored at the carbon dioxide scrubber 515 and/or at a storage tank outside of the carbon dioxide scrubber 515.

Liquefaction 520 is then performed on the dewatered and scrubbed air. With liquefaction 520, dewatered and scrubbed air undergoes a phase change from gas to liquid. Oxygen (O₂) 521 may be used in liquefaction 520. The liquid air formed by liquefaction 520 then passes to distillation 525. At distillation 525, the liquid air may be separated into liquid oxygen (O₂) 526, liquid argon (Ar) 528, and liquid nitrogen (N₂) 527. Each of these gases may be stored in storage tanks, and these storage tanks may be insulated, low-pressure storage tanks. Liquid oxygen 526 and liquid argon 528 may be used for commercial purposes.

Looking now at FIG. 5B, it can be seen that the liquid nitrogen 527 obtained through distillation 525 in FIG. 5A may be used for filling energy storage tanks of cargo airships 535. Liquid nitrogen 527 may be used for filling storage tanks on the ground using ground refill 530 in some embodiments. In some embodiments, liquid nitrogen 527 may be used for filling storage tanks in the air using aerial refill 531.

Cargo airships 535 may pick up cargo and use liquid nitrogen 527 as an energy source. The liquid nitrogen may be expanded to gas, resulting in the release of energy. This released energy may propel the cargo airship 535 so that transportation 540 may be completed. During transportation 540 with the cargo airship 535, the cargo may be transported to its destination. In some embodiments, the only output during transportation 540 of the cargo airship 535 is inert, gaseous nitrogen 541 into the atmosphere. Thus, an environmentally conscious design may be accomplished.

Additionally, scrubbed carbon dioxide 516 may be used for beneficial purposes as well. Molten carbonate electrolysis 545 may be performed to convert the scrubbed carbon dioxide 516 into carbon nanotubes 546. Another byproduct of molten carbonate electrolysis 545 is oxygen 521, which may be utilized in liquefaction 520 as illustrated in FIG. 5A. Molten carbonate electrolysis 545 may be powered by the electricity 502 generated through electricity generation 500, using wind energy 501, and/or using solar energy 503. However, molten carbonate electrolysis 545 may be powered by other energy sources such as thermal energy, electric energy from another source, solar energy from another source, etc.

Carbon nanotubes 546 may be used as a feedstock for component manufacturing 550. Component manufacturing 550 may produce carbon nanotube (CNT) reinforced epoxy resin and spun 551A and/or woven carbon nanotube yarns and fabrics 551B. Component manufacturing 550 may rely upon electricity 502 generated through electricity generation 500. The carbon nanotube reinforced epoxy resin and spun 551A and/or woven carbon nanotube yarns and fabrics 551B may be used in manufacturing 560 of airship components 561, and the manufacturing 560 may be a composite manufacturing process in some embodiments. Manufacturing 560 may be performed to generate airship components 561. However, in other embodiments, the carbon nanotubes 546, the carbon nanotube (CNT) reinforced epoxy resin and spun 551A, and/or the woven carbon nanotube yarns and fabrics 551B may be utilized to generate components for other systems. Manufacturing 560 may rely upon electricity 502 generated through electricity generation 500.

Once manufactured, assembly 570 may be performed so that airship components 561 are assembled into cargo airships 535. In this way, cargo may be transported without carbon dioxide or other greenhouse gas emissions, and with the added benefit of atmospheric carbon dioxide capture within the cargo transport system and carbon sequestration within the cargo airships themselves. Energy for assembly 570 may be provided by electricity 502 generated through electricity generation 500.

In FIGS. 3 and 4, various lines are shown. Additionally, in FIGS. 5A and 5B, various operations are described where substances are transferred from one location to another. In some embodiments, an operator may manually control the flow of liquefied gas and other substances through the system, and this may result in an adjustment of the amount of power generated by the system. The control of the flow of liquefied gas and other substances may be accomplished by an automated electronic digital controller in some embodiments.

In some embodiments, LTA aircraft may utilize energy through liquefied gas expansion alongside other energy sources. For example, the LTA aircraft may utilize energy generated from solar-photovoltaic power alongside energy generated through liquefied gas expansion. In some embodiments, solar-photovoltaic power may be utilized for daytime running, and liquefied gas expansion may be utilized for energy generation during nighttime or periods of low solar availability. In some embodiments, energy generated from solar-photovoltaic power may be stored for use during nighttime or periods of low solar availability, and liquefied gas expansion may be utilized alongside solar-photovoltaic power during the daytime in other embodiments.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A method for generation of liquefied gas comprising:
receiving air;
refining the air to create refined air;
performing liquefaction on the refined air to form liquefied gas;
transferring at least one constituent liquefied gas of the liquefied gas to a storage tank in a lighter than air aircraft,
wherein the at least one constituent liquefied gas of the liquefied gas is configured to serve as an energy source for the lighter than air aircraft.

2. The method of claim 1, further comprising:
distilling the liquefied gas to obtain liquid nitrogen and one or more other constituent gases,
wherein the at least one constituent liquefied gas of the liquefied gas includes the liquid nitrogen.

3. The method of claim 2, wherein the liquid nitrogen is configured to store at least 250 kilojoule per liter of energy.

4. The method of claim 2, wherein the liquid nitrogen possesses a storage temperature of greater than approximately −200 degrees Celsius.

5. The method of claim 2, wherein distilling the liquefied gas generates oxygen and argon.

6. The method of claim 1, wherein refining the air to create refined air includes at least one of:
compressing the air;
separating water from the air;
scrubbing carbon dioxide from the air; or
filtering dust from the air.

7. The method of claim 6, wherein refining the air to create refined air includes scrubbing carbon dioxide from the air, wherein the method further comprises:
performing molten carbonate electrolysis to separate carbon from oxygen.

8. The method of claim 7, further comprising:
manufacturing components of another lighter than air aircraft utilizing separated carbon.

9. The method of claim 1, wherein the method is carbon-neutral or carbon-negative.

10. A lighter than air aircraft comprising:
an air inlet that is configured to receive air;
one or more refinement equipment that is configured to refine the air to generate refined air;
liquefaction equipment that is configured to perform liquefaction on the refined air to form liquefied gas;
a storage tank that is configured to store at least one constituent liquefied gas of the liquefied gas; and
a heat exchanger,
wherein the heat exchanger is configured to induce a phase change in the at least one constituent liquefied gas from liquid to gas, wherein the phase change generates energy, and wherein the lighter than air aircraft is configured to use the energy to power one or more components or systems of the lighter than air aircraft.

11. The lighter than air aircraft of claim 10, wherein the one or more refinement equipment includes at least one of:
an air compressor for compressing the air;
a water filter for separating water from the air;
a carbon dioxide scrubber configured to scrub carbon dioxide from the air; or
a dust filter for filtering dust from the air.

12. The lighter than air aircraft of claim 11, wherein the one or more refinement equipment includes an air compressor for compressing the air, wherein the air compressor is a three-stage compressor.

13. The lighter than air aircraft of claim 10, wherein the liquefied gas is configured to store at least 250 kilojoule per liter of energy.

14. The lighter than air aircraft of claim 10, wherein the lighter than air aircraft is carbon-neutral or carbon-negative.

15. The lighter than air aircraft of claim 10, wherein the liquefaction equipment is configured to perform liquefaction using at least one of a Hampson-Linde cycle, a Siemens cycle, or a Claude cycle.

16. A lighter than air aircraft comprising:
a storage tank that is configured to store a liquefied gas;
a heat exchanger,
wherein the lighter than air aircraft is configured to receive the liquefied gas for the storage tank from a liquefied gas production and storage facility or a second lighter than air aircraft, wherein the heat exchanger is configured to induce a phase change in the liquefied gas from liquid to gas, wherein the phase change generates energy, and wherein the lighter than air aircraft is configured to use the energy to power one or more components or systems of the lighter than air aircraft.

17. The lighter than air aircraft of claim 16, wherein the liquefied gas is nitrogen.

18. The lighter than air aircraft of claim 16, wherein the heat exchanger utilizes at least one of heat from ambient air or solar energy.

19. The lighter than air aircraft of claim 16, further comprising:
a turboexpander; and
a generator,
wherein the liquefied gas is expanded through the turboexpander to convert the energy to rotational motion, and wherein the generator is configured to convert rotational motion into electrical energy.

20. The lighter than air aircraft of claim 16, further comprising:
a deployable boom,
wherein the lighter than air aircraft is configured to receive the liquefied gas from the second lighter than air aircraft using the deployable boom or to transfer the liquefied gas to the second lighter than air aircraft using the deployable boom.
